(19) United States
(12) Patent Application Publication
(10) Pub. No.: US 2016/0154279 A1
(43) Pub. Date: Jun. 2, 2016

(54) Liquid Crystal Display Panel and Fabrication Method Thereof

(71) Applicant: SHENZHEN CHINA STAR OPTOELECTRONICS TECHNOLOGY CO., LTD., Shenzhen (CN)

(72) Inventor: Yuan Xiong, Shenzhen (CN)

(21) Appl. No.: 14/418,083

(22) PCT Filed: Dec. 17, 2014
(86) PCT No.: PCT/CN2014/094023

§ 371 Date: Jan. 29, 2015

(30) Foreign Application Priority Data
Nov. 28, 2014 (CN) 201410709276.7

(51) Int. Cl. G02F 1/1337; G02F 1/1335; G02F 1/1341; G02F 1/1368

(52) U.S. Cl. CPC G02F 1/133788; G02F 1/1368; G02F 1/1337; G02F 1/133514; G02F 1/133711; G02F 1/1341

(57) ABSTRACT

The present invention discloses a display panel and a fabrication process thereof. The display panel includes a thin film transistor (TFT) array substrate, a color filter substrate, and a liquid crystal layer. A first alignment film in the TFT array substrate is provided to supply a first alignment-controlling force to liquid crystal molecules, and the second alignment film in the color filter substrate is provided to supply a second alignment-controlling force to liquid crystal molecules. The present invention can avoid the problem due to formation of the alignment films through mechanical contacts resulting in uneven brightness performance across the display panel.

### BACKGROUND OF THE INVENTION

1. Field of the Invention

The present invention relates to liquid crystal display (LCD) technology, and more particularly to a thin film transistor LCD (TFT-LCD) panel and a method for fabricating the panel.

2. Description of Prior Art

In general, a conventional LCD panel has alignment films provided therein, the alignment films are used in control of alignment characteristics of liquid crystal molecules.

The alignment film is typically formed on a color filter substrate before a TFT array substrate and the color filter substrate are combined as a liquid crystal box. Furthermore, the alignment film is typically disposed on a color filter substrate through a means with mechanical contact, e.g. rubbing process.

In application of large-size LCD display panels, the rubbing process may cause non-uniform contrast i.e. mura, on an LCD display screen.

Accordingly, a new technical solution is required to solve the above mentioned technical problems.

### SUMMARY OF THE INVENTION

It is an object of the present invention to provide a display panel and a method for fabricating the panel, which can avoid the problem due to formation of the alignment films through mechanical contacts resulting in uneven brightness performance across the display panel. Consequently, the probability of display irregularity of the display panel is reduced.

To solve the foregoing problem and achieve the object of the present invention, as embodied, a LCD panel comprises a TFT array substrate that includes at least one pixel unit, the pixel unit being provided with pixel electrodes including a first pixel electrode and a second pixel electrode;

a color filter substrate stacked and combined together with the TFT array substrate as a whole; and

a liquid crystal layer disposed between the color filter substrate and the TFT array substrate and including liquid crystal molecules,

wherein the TFT array substrate further includes:
a first alignment film disposed on a first surface of the TFT array substrate that faces the liquid crystal layer, and the first alignment film being provided to supply a first alignment-controlling force to the liquid crystal molecules of the liquid crystal layer near the first surface;

wherein the color filter substrate further includes:
a second alignment film disposed on a second surface of the color filter array substrate that faces the liquid crystal layer, and the second alignment film being provided to supply a second alignment-controlling force to the liquid crystal molecules of the liquid crystal layer near the second surface of the liquid crystal layer;

wherein the pixel unit applies a first electric field to the liquid crystal molecules, and the first electric field is formed due to a voltage difference existing between the first pixel electrode and the second pixel electrode, and

wherein the TFT array substrate and the color filter substrate are electrically insulated from each other.

In the above embodiment of the present invention, the first alignment film is formed by using ultraviolet irradiation to polymerize the first polymerizable monomers, while the second alignment film is formed by using ultraviolet irradiation to polymerize a second polymerizable monomers, and the first polymerizable monomers and the second polymerizable monomers are mingled together in the liquid crystal layer.

In the above embodiment of the present invention, the color filter substrate further comprises an electrode layer disposed between the second surface and the second alignment film, and the electrode layer and the pixel electrodes jointly form the first alignment film and the second alignment film.

In the above embodiment of the present invention, the first alignment film is formed by driving the first polymer monomers to gather on the first surface under an effect of a second electric field and being irradiated by an ultraviolet light; the second electric field is created by applying a voltage to the electrode layer and the pixel electrodes to polymerize and cure; and the second alignment film is formed by driving the second polymerizable monomers to gather on the second surface under the effect of the second electric field and being irradiated by an ultraviolet light to polymerize and cure the second polymerizable monomers.

In the above embodiment of the present invention, a first groove array is disposed on a third surface of the electrode layer and includes at least two of the first grooves for shaping the second alignment film during the formation process of the second alignment film, and thereby a second groove array, being a counterpart of the first groove array, is formed on a fourth surface of the second alignment film; wherein the third surface is a surface of the electrode layer facing the liquid crystal layer and the fourth surface is a surface of the second alignment film facing the liquid crystal layer.

According to another embodiment of the present invention, a TFT array substrate that includes at least one pixel unit, the pixel unit being provided with pixel electrodes including a first pixel electrode and a second pixel electrode;

a color filter substrate stacked and combined together with the TFT array substrate as a whole; and

a liquid crystal layer disposed between the color filter substrate and the TFT array substrate and including liquid crystal molecules,

wherein the TFT array substrate further includes:

a first alignment film disposed on a first surface of the TFT array substrate that faces the liquid crystal layer, and the first alignment film being provided to supply a first alignment-controlling force to the liquid crystal molecules of the liquid crystal layer near the first surface;

wherein the color filter substrate further includes:
a second alignment film disposed on a second surface of the color filter array substrate that faces the liquid crystal layer, and the second alignment film being provided to supply a second alignment-controlling force to the liquid crystal molecules of the liquid crystal layer near the second surface of the liquid crystal layer;

wherein the pixel unit applies a first electric field to the liquid crystal molecules, and the first electric field is formed due to a voltage difference existing between the first pixel electrode and the second pixel electrode.

In the another embodiment of the present invention, the first alignment film is formed by using ultraviolet irradiation to polymerize the first polymerizable monomers while the second alignment film is formed by using ultraviolet irradiation to polymerize a second polymerizable monomers, and the first polymerizable monomers and the second polymerizable monomers are mingled together in the liquid crystal layer.

In the another embodiment of the present invention, the first polymerizable monomers and the second polymerizable monomers are mingled together among the liquid crystal molecules before the liquid crystal molecules are injected into the liquid crystal box.

In the another embodiment of the present invention, the color filter substrate further comprises an electrode layer disposed between the second surface and the second alignment film, and the electrode layer and the pixel electrodes jointly form the first alignment film and the second alignment film.

In the another embodiment of the present invention, the first alignment film is formed by driving the first polymerizable monomers to gather on the first surface under an effect of a second electric field and being irradiated by an ultraviolet light; the second electric field is created by applying a voltage to the electrode layer and the pixel electrodes to polymerize and cure; and the second alignment film is formed by driving the second polymerizable monomers to gather on the second surface under the effect of the second electric field and being irradiated by an ultraviolet light to polymerize and cure the second polymerizable monomers.

In the another embodiment of the present invention, the second electric field can be formed by using an additional conductor to connect the pixel electrodes and the electrode layer of the color filter substrate at first, and then a voltage is applied between the pixel electrodes of the TFT array substrate and the electrode layer of the color filter substrate through the additional conductor to create a second voltage difference between them.

In the another embodiment of the present invention, a first groove array disposed on a third surface of the electrode layer includes at least two of the first grooves for shaping the second alignment film during the formation process of the second alignment film, and thereby a second groove array, being a counterpart of the first groove array, is formed on a fourth surface of the second alignment film; wherein the third surface is a surface of the electrode layer facing the liquid crystal layer and the fourth surface is a surface of the second alignment film facing the liquid crystal layer.

In the another embodiment of the present invention, the second groove array disposed on the fourth surface of the electrode layer includes at least two of the second grooves.

In the another embodiment of the present invention, the TFT array substrate and the color filter substrate are electrically insulated from each other.

Specifically, the present invention provides a method for fabricating a LCD panel including the following steps:

A: stacking the color filter substrate and the TFT array substrate and combining them together as a whole piece;

B: injecting the liquid crystal molecules into between the TFT array substrate and the filter substrate; and

C: disposing the first alignment film and the second alignment film respectively on a first surface and a second surface.

According to the above method, the method also includes a step D: disposing the electrode layer on the second surface of the color filter substrate.

According to the above method, the method also includes a step E: disposing a first groove array on the third surface of the electrode layer for shaping the second alignment film during the formation process of the second alignment film and thereby a second groove array, being a counterpart of the first groove array, is formed on the fourth surface of the second alignment.

According to the above method, the method also includes a step F: mingling the first polymerizable monomers and the second polymerizable monomers together among the liquid crystal molecules.

According to the above method, the above step C comprises the following steps:

c1: applying a voltage to the TFT array substrate and the color filter substrate to make the first polymerizable monomers and the second polymerizable monomers gather separately on the first surface and the second surface; and

c2: forming the first alignment film and the second alignment film by using ultraviolet irradiation to polymerize and cure the first polymerizable monomers and the second polymerizable monomers.

According to the above method, the step C of the method further comprises the following step prior to the step c1:

c3: forming the second electric field by using an additional conductor to connect the pixel electrodes and the electrode layer of the color filter substrate, and then applying a voltage to the pixel electrode and the electrode layer through the additional conductor to create a second voltage difference between the pixel electrode and the electrode layer.

With the technical solution of the present invention, the first alignment film disposed on the TFT array substrate and the second alignment film disposed on the color filter substrate are formed through a means without mechanical contact. Consequently, the uneven brightness performance, i.e. Mura phenomenon, across the display panel can be avoided such that the problem can be avoided due to mechanical contacts resulting in uneven brightness performance, i.e. Mura, across the display panel. Simultaneously, the probability of display irregularity and visual defects are reduced.

These and various other features as well as advantages, which characterize the disclosure presented herein, will be apparent from a reading of the following detailed description and a review of the associated drawings.

### BRIEF DESCRIPTION OF THE DRAWINGS

FIG. 1 is a diagram that illustrates the color filter substrate according to an embodiment of the present invention.

FIG. 2 to FIG. 4 are schematic diagrams that illustrate the formations of the first alignment film and the second alignment film within a display panel according to an embodiment of the present invention.

FIG. 5 is schematic diagram that illustrates a display panel according to an embodiment of the present invention.

FIG. 6 is a flow chart that illustrates a method for fabricating a display panel according to the first embodiment of the present invention.

FIG. 7 is a flow chart that illustrates a method for fabricating a display panel according to the second embodiment of the present invention.

FIG. 8 is a flow chart that illustrates a method for fabricating a display panel according to the third embodiment of the present invention.

### DETAILED DESCRIPTION OF THE INVENTION

Embodiments of the present invention will be described in detail with reference to the drawings. Note that these embodiments are merely as examples to illustrate the technical aspect of the present invention, rather than its restrictions. In the detailed description and claims, the indefinite article “a” or “an” does not exclude a plurality.

A TFT-LCD panel according to an embodiment of the present invention and a fabrication method used therein will now be described in detail.

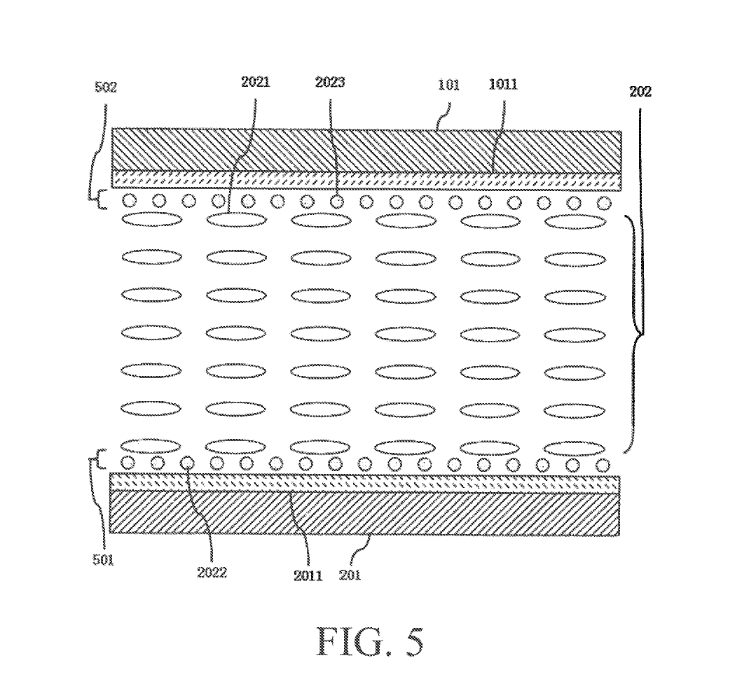

FIG. 5 is schematic diagram that illustrates a display panel according to an embodiment of the present invention. The display panel in this embodiment includes a TFT array substrate 201, a color filter substrate 101 and a liquid crystal layer 202. A first alignment film disposed on the TFT array substrate is provided to supply a first alignment force, and a second alignment film disposed on the color filter substrate is provided to supply a second alignment force. The color filter substrate 101 and the TFT array substrate 201 are stacked and combined together as a whole piece to form a liquid crystal box. The liquid crystal layer 202 is disposed between the color filter substrate 101 and the TFT array substrate 201. The liquid crystal layer 202 includes liquid crystal molecules 2021.

The TFT array substrate 201 includes at least one pixel unit. A plurality of pixel electrodes 2011 disposed in the pixel unit includes a first pixel electrode and a second pixel electrode. The TFT array substrate 201 also includes a first alignment film 501. The first alignment film 501 is disposed on a first surface, facing the liquid crystal layer 202, and the first alignment film 501 is provided to supply a first alignment-controlling force (a first anchoring force) to liquid crystal molecules 2021 of the liquid crystal layer 202 near the first surface.

The color filter substrate 101 includes a second alignment film 502. The second alignment film 502 is disposed on a second surface of the color filter array substrate 101, facing another surface of the liquid crystal layer 202, and the second alignment film 502 is provided to supply a second alignment-controlling force (a second anchoring force) to liquid crystal molecules 2021 of the liquid crystal layer 202 near another surface of the liquid crystal layer 202.

There is a voltage difference existing between the first pixel electrode and the second pixel electrode disposed in the pixel unit to form a first electric field. The pixel unit is used for applying the first electric field to liquid crystal molecules 2021.

In the above mentioned panel, the TFT array substrate 201 and the color filter substrate 101 are electrically insulated from each other. Namely, the connection between the TFT array substrate 201 and the color filter substrate 101 is electrically non-conductive means. In other words, the TFT array substrate 201 and the color filter substrate 101 are not electrically connected. Therefore, the liquid crystal molecules 2021 are not exerted any electric force from the color filter substrate 101.

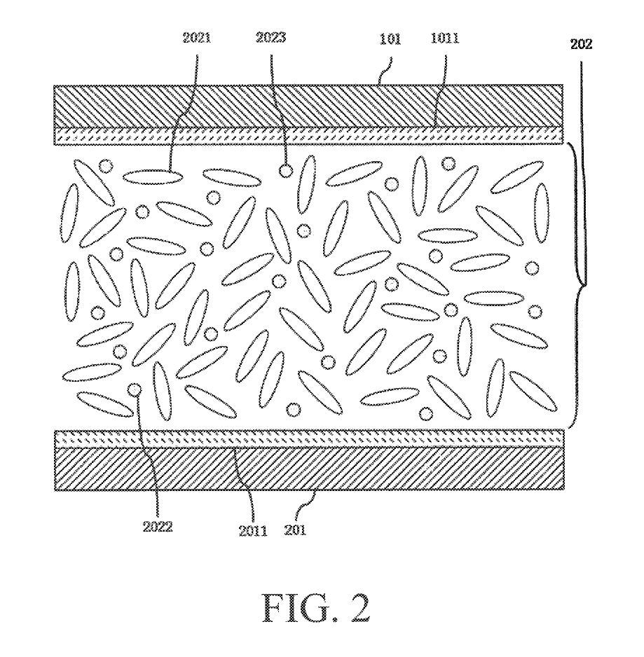

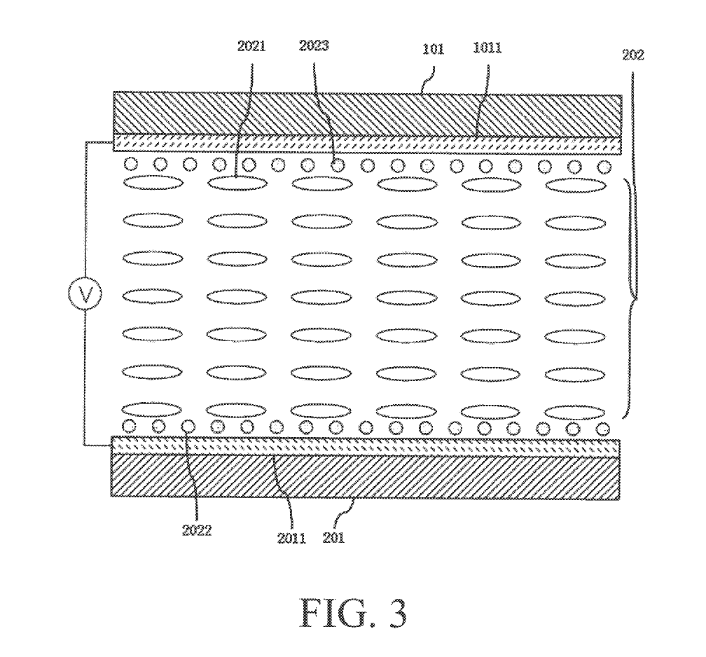

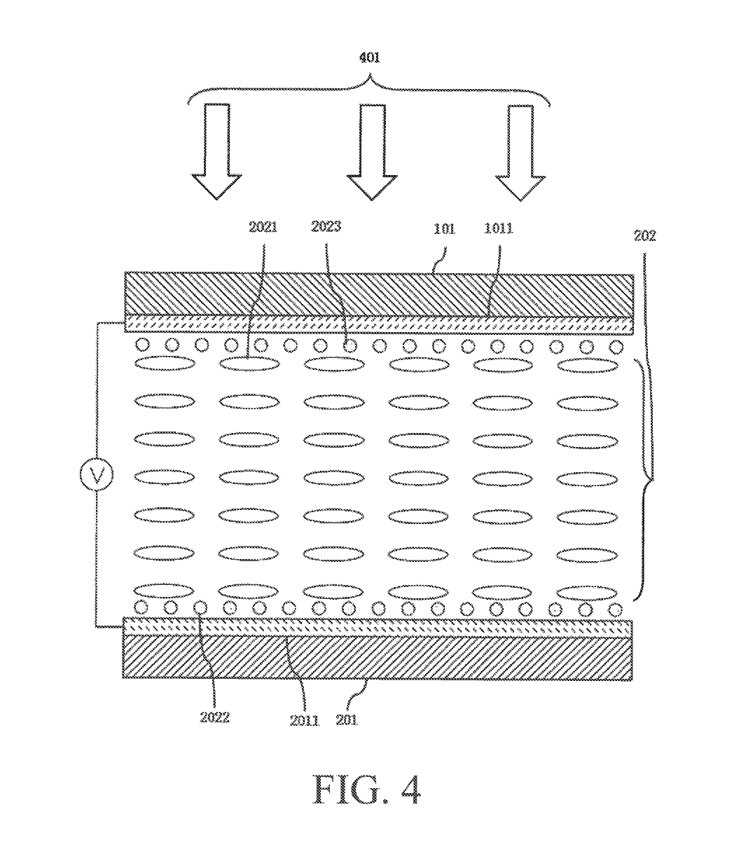

FIG. 2 to FIG. 4 are schematic diagrams that illustrate the formations of the first alignment film 501 and the second alignment film 502 within a display panel according to an embodiment of the present invention.

In this embodiment, the first alignment film 501 is formed by using ultraviolet irradiation 401 to polymerize a first polymerizable monomers 2022 while the second alignment film 502 is formed by using ultraviolet irradiation 401 to polymerize a second polymerizable monomers 2023.

The first polymerizable monomers 2022 and the second polymerizable monomers 2023 are mingled together in the liquid crystal layer 202, more specifically, the first polymerizable monomers 2022 and the second polymerizable monomers 2023 are mingled together among the liquid crystal molecules 2021 before the liquid crystal molecules 2021 are injected into the liquid crystal box. The first polymerizable monomers 2022 and the second polymerizable monomers 2023 have an identical structure.

In this embodiment, the color filter substrate 101 also includes an electrode layer 1011. The electrode layer 1011 is disposed between the second surface and the second alignment film 502. The pixel electrodes 2011 and the electrode layer 1011 jointly form the first alignment film 501 and the second alignment film 502.

The first alignment film 501 therein is formed by using ultraviolet irradiation 401 to polymerize the first polymerizable monomers 2022 which are gathered on the first surface under the effect of the second electric field. The aforementioned second electric field is formed by applying a voltage to the electrode layer 1011 and the pixel electrodes 2011 to polymerize and cure. The second alignment film 502 therein is formed by using ultraviolet irradiation 401 to polymerize and cure the second polymerizable monomers 2023 which are gathered on the second surface under the effect of the second electric field. The aforementioned second electric field can be formed by using an additional conductor to connect the pixel electrodes 2011 and the electrode layer 1011 of the color filter substrate 101 at first, and then a voltage is applied between the pixel electrodes 2011 and the electrode layer 1011 of the color filter substrate 101 through the additional conductor to create a second voltage difference between the pixel electrodes 2011 and the electrode layer 1011 of the color filter substrate 101. As such, the aforementioned second electric field is formed.

According to the aforementioned embodiment, the first alignment film 501 disposed on the TFT array substrate 201 and/or the second alignment film 502 disposed on the color filter substrate 101 are/is formed through a means without mechanical contact, and the liquid crystal molecules 2021 close to the TFT array substrate 201 and/or the color filter substrate 101 are aligned. Consequently, the uneven brightness performance, i.e. Mura phenomenon, across the display panel can be avoided such that the problem can be avoided due to mechanical contacts resulting in uneven brightness performance, i.e. Mura, across the display panel. Simultaneously, the probability of display irregularity is reduced.

In addition, a display panel fabricated by the aforementioned solution is favorable to provide larger alignment-controlling forces (anchoring forces) to the liquid crystal molecules 2021 and consequently a display response time of the display panel is shorten.

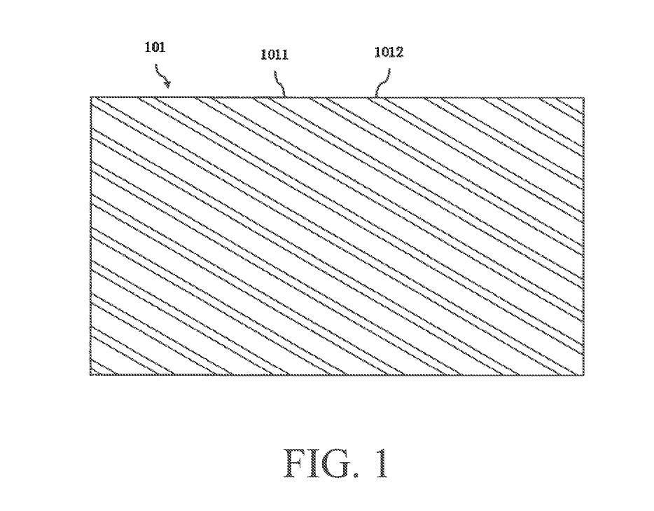

FIG. 1 is a diagram that illustrates the color filter substrate 101 according to an embodiment of the present invention. There is a first groove array disposed on the third surface of the electrode layer 1011, wherein the first groove array includes at least two grooves 1012 for shaping the second alignment film 502 during the formation process of the second alignment film 502 and make a second groove array overlie the fourth surface of the second alignment 502, wherein the second groove array having at least two grooves is a counterpart of the first groove array.

The aforementioned third surface of the electrode layer 1011 means a surface which faces the liquid crystal layer 202, and the aforementioned fourth surface of the second alignment 502 means a surface which faces the liquid crystal layer 202.

In one embodiment of the present invention, the liquid crystal molecules 2021 align along the direction of the second grooves when the display panel is turned on and working, i.e. the TFT array substrate 201 powered up, because a first groove array is disposed on the third surface of the electrode layer 1011. As such, it is favorable to have a good performance in a dark state for the display panel.

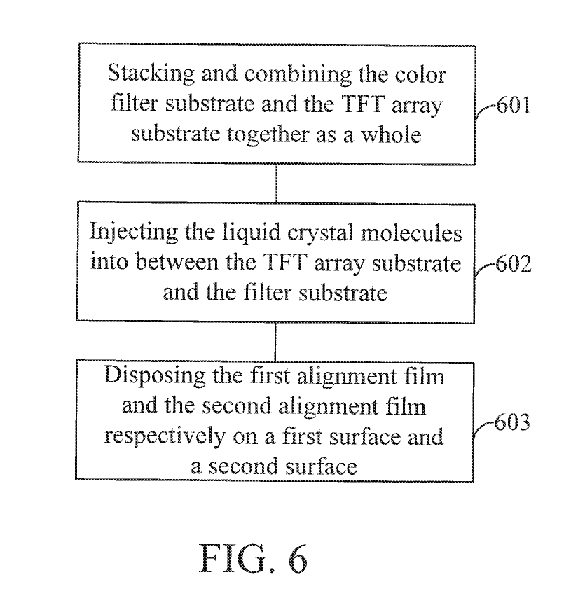

FIG. 6 is a flow chart that illustrates a method for fabricating a display panel according to the first embodiment of the present invention. The method for fabricating a display panel according to the first embodiment of the present invention includes following steps:

A (Step 601): Stacking and combining the color filter substrate 101 and the TFT array substrate 201 together as a whole piece to form a liquid crystal box.

B (Step 602): Injecting the liquid crystal molecules 2021 into the liquid crystal box which are between the TFT array substrate 201 and the filter substrate 101.

C (Step 603): Disposing the first alignment film 501 and the second alignment film 502 respectively on a first surface and a second surface.

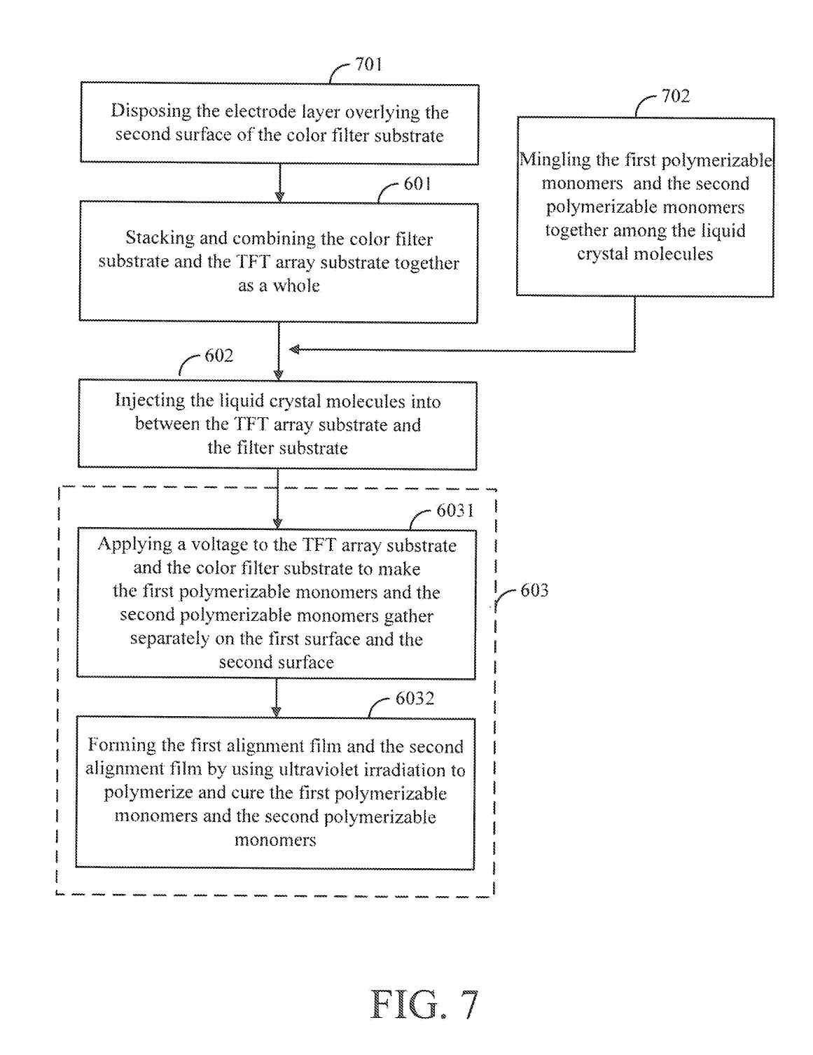

Correspondingly referring to the FIG. 2-FIG. 4 and FIG. 7, FIG. 7 is a flow chart that illustrates a method for fabricating a display panel according to the second embodiment of the present invention. The difference between the first embodiment and the second embodiment includes further steps:

Prior to step A (Step 601), the method for fabricating a display panel further comprises the following step:

D (Step 701): Disposing the electrode layer 1011 on the second surface of the color filter substrate 101.

Prior to step B (Step 602), the method for fabricating a display panel further comprises the following step:

F (Step 702): Mingling the first polymerizable monomers 2022 and the second polymerizable monomers 2023 together among the liquid crystal molecules 2021.

The aforementioned step C (Step 603) comprises the following steps:
c1 (Step 6031): Applying a voltage between the TFT array substrate 201 and the color filter substrate 101 to drive the first polymerizable monomers 2022 and the second polymerizable monomers 2023 gather separately on the first surface and the second surface.
c2 (Step 6032): Forming the first alignment film 501 and the second alignment film 502 by using ultraviolet irradiation 401 to polymerize and cure the first polymerizable monomers 2022 and the second polymerizable monomers 2023.

Prior to step C1 (Step 6031), the aforementioned step C (Step 603) further comprises the following step:
c3: Forming the second electric field by using an additional conductor to connect the pixel electrodes 2011 and the electrode layer 1011 of the color filter substrate 101 at first, and then a voltage is applied between the pixel electrodes 2011 and the electrode layer 1011 of the color filter substrate 101 through the additional conductor to create a second voltage difference between the pixel electrodes 2011 and the electrode layer 1011 of the color filter substrate 101.

In this way, the first alignment film 501 disposed on the TFT array substrate 201 and/or the second alignment film 502 disposed on the color filter substrate 101 are/is formed through a means without mechanical contact such that the problem can be avoided due to mechanical contacts resulting in uneven brightness performance, i.e. Mura, across the display panel. Simultaneously, the probability of display irregularity is reduced.

Furthermore, it is favorable to provide larger alignment-controlling forces (anchoring forces) to the liquid crystal molecules 2021 that a display panel uses the method for fabrication according to the second embodiment of the present invention. Consequently, a display response time of the display panel is shortened.

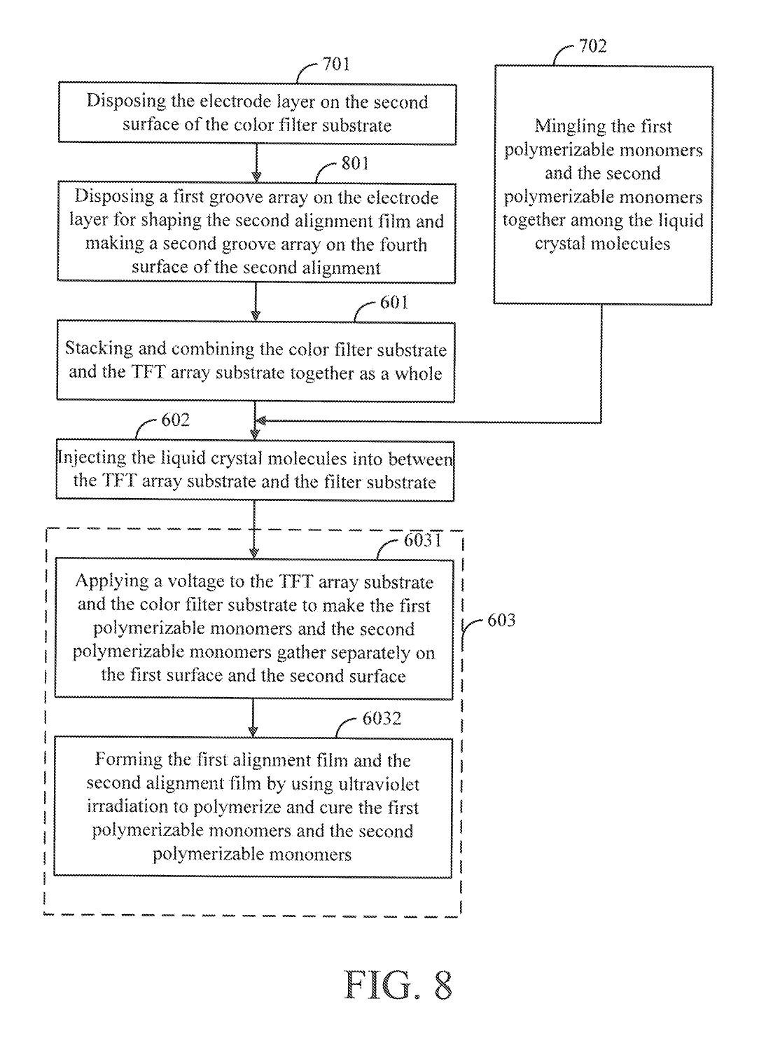

Correspondingly referring to the FIG. 1 and FIG. 8, FIG. 8 is a flow chart that illustrates a method for fabricating a display panel according to the third embodiment of the present invention. The difference between the second embodiment and the third embodiment includes further steps:

Subsequent to step D (Step 701), the method for fabricating a display panel further comprises the following step:

E (Step 801): Disposing a first groove array on the third surface of the electrode layer 1011 for shaping the second alignment film 502 during the formation process of the second alignment film 502 and make a second groove array overlie the fourth surface of the second alignment 502.

The aforementioned first groove array includes at least two grooves 1012, and the aforementioned second groove array also includes at least two grooves. Besides, the second groove array is a counterpart of the first groove array.

In the third embodiment, the liquid crystal molecules 2021 align along the direction of the second grooves when the display panel is turned on and working, i.e. the TFT array substrate 201 powered up, because a first groove array is disposed on the third surface of the electrode layer 1011. As such, it is favorable to have a good performance in a dark state for the display panel.

While the preferred embodiments of the present invention have been illustrated and described, those having ordinary skills in the art may easily contemplate various changes and modifications according to the disclosure and drawings of the present invention. As various changes and modifications could be made about the disclosed method, a wide variety of combinations and selections of various elements for acting as similar functions even having distinct structures are within the scope of aspects of the disclosure. In the claims, the word “comprising” does not exclude other elements or steps, and the indefinite article “a” or “an” does not exclude a plurality.

It is noted that the specifications relating to the above embodiments should be construed as exemplary rather than as limitative of the present invention, any modification of equivalent structure, equivalent function or equivalent method made directly or indirectly, to other related fields of technique, is considered encompassed in the scope of protection defined by the claims of the present invention.

1. A display panel comprising:
a TFT (thin film transistor) array substrate which includes at least one pixel unit, the pixel unit being provided with pixel electrodes including a first pixel electrode and a second pixel electrode;
a color filter substrate stacked and combined together with the TFT array substrate as a whole; and
a liquid crystal layer disposed between the color filter substrate and the TFT array substrate and including liquid crystal molecules,
wherein the TFT array substrate further includes:
a first alignment film disposed on a first surface of the TFT array substrate that faces the liquid crystal layer, and the first alignment film being provided to supply a first alignment-controlling force to the liquid crystal molecules of the liquid crystal layer near the first surface;
wherein the color filter substrate further includes:
a second alignment film disposed on a second surface of the color filter substrate that faces the liquid crystal layer, and the second alignment film being provided to supply a second alignment-controlling force to the liquid crystal molecules of the liquid crystal layer near the second surface of the liquid crystal layer;
wherein the pixel unit applies a first electric field to the liquid crystal molecules, and the first electric field is formed due to a voltage difference existing between the first pixel electrode and the second pixel electrode, and
wherein the TFT array substrate and the color filter substrate are electrically insulated from each other.

2. The panel according to claim 1, wherein the first alignment film is formed by using ultraviolet irradiation to polymerize the first polymerizable monomers, while the second alignment film is formed by using ultraviolet irradiation to polymerize a second polymerizable monomers, and the first polymerizable monomers and the second polymerizable monomers are mingled together in the liquid crystal layer.

3. The panel according to claim 1, wherein the color filter substrate further comprises an electrode layer disposed between the second surface and the second alignment film, and the electrode layer and the pixel electrodes jointly form the first alignment film and the second alignment film.

4. The panel according to claim 3, wherein the first alignment film is formed by driving the first polymer monomers to gather on the first surface under an effect of a second electric field and being irradiated by an ultraviolet light to polymerize and cure the first polymerizable monomers; the second electric field is created by applying a voltage to the electrode layer and the pixel electrodes; and the second alignment film is formed by driving the second polymerizable monomers to gather on the second surface under the effect of the second electric field and being irradiated by an ultraviolet light to polymerize and cure the second polymerizable monomers.

5. The panel according to claim 3, wherein a first groove array is disposed on a third surface of the electrode layer and includes at least two of the first grooves for shaping the second alignment film during the formation process of the second alignment film, and thereby a second groove array, being a counterpart of the first groove array, is formed on a fourth surface of the second alignment film; wherein the third surface is a surface of the electrode layer facing the liquid crystal layer and the fourth surface is a surface of the second alignment film facing the liquid crystal layer.

6. A display panel comprising:
a TFT array substrate which includes at least one pixel unit, the pixel unit being provided with pixel electrodes including a first pixel electrode and a second pixel electrode;
a color filter substrate stacked and combined together with the TFT array substrate as a whole; and
a liquid crystal layer disposed between the color filter substrate and the TFT array substrate and including liquid crystal molecules,
wherein the TFT array substrate further includes:
a first alignment film disposed on a first surface of the TFT array substrate that faces the liquid crystal layer, and the first alignment film being provided to supply a first alignment-controlling force to the liquid crystal molecules of the liquid crystal layer near the first surface;
wherein the color filter substrate further includes:
a second alignment film disposed on a second surface of the color filter substrate that faces the liquid crystal layer, and the second alignment film being provided to supply a second alignment-controlling force to the liquid crystal molecules of the liquid crystal layer near the second surface of the liquid crystal layer;
wherein the pixel unit applies a first electric field to the liquid crystal molecules, and the first electric field is formed due to a voltage difference existing between the first pixel electrode and the second pixel electrode.

7. The panel according to claim 6, wherein the first alignment film is formed by using ultraviolet irradiation to polymerize the first polymerizable monomers while the second alignment film is formed by using ultraviolet irradiation to polymerize a second polymerizable monomers, and the first polymerizable monomers and the second polymerizable monomers are mingled together in the liquid crystal layer.

8. The panel according to claim 7, wherein the first polymerizable monomers and the second polymerizable monomers are mingled together among the liquid crystal molecules before the liquid crystal molecules are injected into the liquid crystal box.

9. The panel according to claim 6, wherein the color filter substrate further comprises an electrode layer disposed between the second surface and the second alignment film, and the electrode layer and the pixel electrodes jointly form the first alignment film and the second alignment film.

10. The panel according to claim 9, wherein the first alignment film is formed by driving the first polymerizable monomers to gather on the first surface under an effect of a second electric field and being irradiated by an ultraviolet light to polymerize and cure the first polymerizable monomers; the second electric field is created by applying a voltage to the electrode layer and the pixel electrodes; and the second alignment film is formed by driving the second polymerizable monomers to gather on the second surface under the effect of the second electric field and being irradiated by an ultraviolet light to polymerize and cure the second polymerizable monomers.

11. The panel according to claim 10, wherein the second electric field can be formed by using an additional conductor to connect the pixel electrodes and the electrode layer of the color filter substrate at first, and then a voltage is applied between the pixel electrodes of the TFT array substrate and the electrode layer of the color filter substrate through the additional conductor to create a second voltage difference between them.

12. The panel according to claim 9, wherein a first groove array disposed on a third surface of the electrode layer includes at least two of the first grooves for shaping the second alignment film during the formation process of the second alignment film, and thereby a second groove array, being a counterpart of the first groove array, is formed on a fourth surface of the second alignment film; wherein the third surface is a surface of the electrode layer facing the liquid crystal layer and the fourth surface is a surface of the second alignment film facing the liquid crystal layer.

13. The panel according to claim 12, wherein the second groove array disposed on the fourth surface of the electrode layer includes at least two of the second grooves.

14. The panel according to claim 6, wherein the TFT array substrate and the color filter substrate are electrically insulated from each other.

15. A method for fabricating a LCD panel of claim 6, comprising the steps of:
A: stacking the color filter substrate and the TFT array substrate and combining them together as a whole piece;
B: injecting the liquid crystal molecules into between the TFT array substrate and the filter substrate; and
C: disposing the first alignment film and the second alignment film respectively on a first surface and a second surface.

16. The method according to claim 15, further comprising the following step prior to step A:
D: disposing the electrode layer on the second surface of the color filter substrate.

17. The method according to claim 16, further comprising the following step subsequent to the disposing step (step D):
E: disposing a first groove array on the third surface of the electrode layer for shaping the second alignment film during the formation process of the second alignment film and thereby a second groove array, which is a counterpart of the first groove array, is formed on the fourth surface of the second alignment.

18. The method according to claim 15, further comprising the following step prior to step B:
F: mingling the first polymerizable monomers and the second polymerizable monomers together among the liquid crystal molecules.

19. The method according to claim 15, wherein the step C comprises the following steps:
c1: applying a voltage to the TFT array substrate and the color filter substrate to make the first polymerizable monomers and the second polymerizable monomers gather separately on the first surface and the second surface; and
c2: forming the first alignment film and the second alignment film by using ultraviolet irradiation to polymerize and cure the first polymerizable monomers and the second polymerizable monomers.

20. The method according to claim 19, wherein the step C further comprises the following step prior to the step c1:
c3: forming the second electric field by using an additional conductor to connect the pixel electrodes and the electrode layer of the color filter substrate, and then applying a voltage to the pixel electrode and the electrode layer through the additional conductor to create a second voltage difference between the pixel electrode and the electrode layer.
